(19) United States
(12) Patent Application Publication
(10) Pub. No.: US 2022/0227399 A1
(43) Pub. Date: Jul. 21, 2022

(54) Method for Operating a Driver Assistance System of an at Least Partially Electrically Operable Motor Vehicle for Controlling Four Wheels, a Driver Assistance System and Motor Vehicle

(71) Applicant: Daimler AG, Stuttgart (DE)

(72) Inventor: Joerg KNEIP, Graz (AT)

(21) Appl. No.: 17/606,384

(22) PCT Filed: Mar. 19, 2020
(86) PCT No.: PCT/EP2020/057680

§ 371 Date: Oct. 25, 2021

(30) Foreign Application Priority Data
Apr. 26, 2019 (DE) 10 2019 003 008.7

(51) Int. Cl. B60W 60/00; B60W 50/08; B60W 50/14

(52) U.S. Cl. CPC B60W 60/0061; B60W 60/0059; B60W 50/082; B60W 2510/0638; B60W 2510/20; B60W 2050/146; B60W 50/14

(57) ABSTRACT

A method for operating a driver assistance system of an electrically driven motor vehicle includes providing a first and a second driving mode and setting the first driving mode or the second driving mode via an actuating device by a single user input. A first turning maneuver of the motor vehicle is set as the first driving mode and a second turning maneuver of the motor vehicle is set as the second driving mode. During the first turning maneuver, a direction of movement for each of the four wheels of the motor vehicle is respectively set via four control signals such that right side wheels of the motor vehicle and left side wheels of the motor vehicle rotate against each other. Via the driver assistance system, the motor vehicle is operated at least partially autonomously at least during the first driving mode and/or the second driving mode.

### BACKGROUND AND SUMMARY OF THE INVENTION

The invention relates to a method for operating a driver assistance system of an at least partially electrically operable motor vehicle, in which a first wheel of the motor vehicle is driven by means of a first control signal, a second wheel of the motor vehicle is driven by means of a second control signal, a third wheel of the motor vehicle is driven by means of a third control signal, and a fourth wheel of the motor vehicle is driven by means of a fourth control signal, all independently of one another, wherein at least one first driving mode is provided for the motor vehicle depending on the four control signals. Furthermore, the invention relates to a driver assistance system and a motor vehicle.

It is already known from the prior art that a respective wheel of the motor vehicle can be controlled individually. In particular, this can also be referred to as all-wheel drive. Furthermore, it is known, for example, that in a track vehicle, a respective chain, for example in an excavator, can be controlled separately, wherein in order to move the chain, two user inputs are again required separately for each chain in order to be able to move the corresponding chains.

By way of example, DE 40 05 356 A1 discloses a vehicle having a plurality of chassis whose axles are adjustable relative to one another in such a way that each chassis has at least two driveable wheels and one motor each. Ideally, each wheel, which can also be designed as a wheel chain, is equipped with an individually controllable, reversible motor. This enables the vehicle to be steered or turned, or to be rotated on the spot without moving the load, by specifying only the drive speed and drive direction of the motor by a corresponding programmable device. The vehicle can be operated autonomously by programs or with the aid of a remote control.

Furthermore, EP 1 186 514 A2 discloses a vehicle with a very small turning circle that can turn on the spot, as may be provided for lawn mowers and windrowers, for example. These often have freewheeling wheels in combination with single-wheel steering driven wheels for steering. Such arrangements are difficult to handle, particularly when driving over terrain that slopes sideways, and can therefore limit the usability of the vehicle. A steering arrangement is proposed which provides appropriate steering properties without the use of a mechanical reinforcing device.

Furthermore, DE 196 46 559 A1 discloses electronic parking aids for motor vehicles having devices for detecting and indicating obstacles or an available parking spaces. Steering angle sensors and an electronic computer and control system are also provided which, on the basis of the detected data on the available parking space, on the current vehicle position and on the current steering angle, calculates a parking maneuver and prescribes it to the vehicle driver by specifying the required driving and steering maneuvers with the aid of optical or acoustic display devices.

The object of the present invention is to create a method, a driver assistance system and a motor vehicle by means of which improved maneuvering of the motor vehicle can be implemented.

This object is solved by a method, a driver assistance system and a motor vehicle according to the independent claims. Advantageous designs of the invention are specified in the dependent claims.

One aspect of the invention relates to a method for operating a driver assistance system of an at least partially electrically operable motor vehicle, in which a first wheel of the motor vehicle is driven by means of a first control signal, a second wheel of the motor vehicle is driven by means of a second control signal, a third wheel of the motor vehicle is driven by means of a third control signal, and a fourth wheel of the motor vehicle is driven by means of a fourth control signal, all independently of one another, wherein at least one first driving mode is provided for the motor vehicle depending on the four control signals.

It is provided that at least one second driving mode is additionally provided depending on the four control signals, wherein the first driving mode or the second driving mode are set by means of an actuating device of the driver assistance system by a single user input, and the four control signals are generated depending on the user input by means of an electronic computing device of the driver assistance system for actuating the four wheels depending on the set driving mode.

This makes is possible for the four wheels to be driven independently of one another and, in particular, relative to one another. This makes it possible to implement improved maneuvering of the motor vehicle, in particular in a rough terrain environment, which can also be referred to as an off-road environment, and also on a road. This also makes it possible for the motor vehicle to be rotated or turned not only by a steering angle on a steering device of the motor vehicle, but additionally or solely by the relative rotation of the wheels with respect to one another, wherein this is implemented in particular between the two wheels on one side of the motor vehicle.

The first driving mode and the second driving mode are to be understood in particular as a respective driving maneuver, i.e., the movement of the motor vehicle. The motor vehicle is in particular a motor vehicle with all-wheel drive.

The single user input is in particular to be understood to mean that the user merely selects the driving mode as user input and that the selection of the driving mode generates the corresponding control signals for the wheels. Thus, the user only has to select the driving mode and the control is carried out independently by means of the electronic computing device. Thus, as in the prior art, two user inputs are not necessary to perform a maneuvering of the motor vehicle, in particular a turning of the motor vehicle. In this way, an increased level of driving comfort for the user is implemented with increased maneuverability of the motor vehicle.

In particular, it can be provided that the method according to the invention can be permanently installed in the motor vehicle as steering assistance. Alternatively, this can also be activated only under certain conditions and, for example, support and improve the driving behaviour of the motor vehicle in the sense of “agile steering” with so-called torque vectoring. In particular, however, it can be provided that the corresponding different or independent control of the wheels is only implemented in a special driving mode, present in the first driving mode and in the second driving mode, such that the first driving mode and the second driving mode differ from a regular driving operation of the motor vehicle.

In particular, according to the invention, this can improve the cornering- and turning trajectory of the motor vehicle.

In particular, it can be provided that the motor vehicle is an at least partially off-road motor vehicle. This makes it possible, for example, to implement a rotation or turn of the motor vehicle off-road with the smallest possible space requirement for the motor vehicle.

According to an advantageous design, different speeds and/or torques and/or directions of movement of the four wheels are set in each case by means of the four control signals. In other words, the speed and/or torque and/or direction of movement of the respective wheel can be set by means of the control signal. In this way, it is made possible that the wheels can move or are moved relative to one another. This enables a high degree of flexibility of the motor vehicle, such that the motor vehicle can be rotated or turned with a small space requirement. This increases the maneuverability of the motor vehicle.

It has further proved to be advantageous if a respective wheel is driven by means of a respective electric motor assigned to the wheel. In particular, this provides an all-wheel drive in which each wheel is driven by its own controllable electric motor. This can take place, for example, via an electric motor close to the wheel for each wheel individually or by a respective wheel hub motor in a respective wheel. In this way, each wheel is assigned a free drive power by an electric motor, such that free torques, speeds as well as a direction of movement can be assigned to each wheel. This increases the maneuverability of the motor vehicle.

In a further advantageous design, a first turning maneuver of the motor vehicle is set as the first driving mode and a second turning maneuver, which differs from the first turning maneuver, of the motor vehicle is set as the second driving mode. The first turning maneuver can, for example, be an off-road turn, i.e., a turning maneuver on rough terrain. During the off-road turn, the wheels of the right side of the motor vehicle and the left side of the motor vehicle turn against each other. A left turn can be implemented by the left side turning backwards and the right side turning forwards. A right turn can be implemented by the right side turning backwards and the left side turning forwards. In particular, high maneuverability can thus be implemented on the rough terrain surrounding the motor vehicle. Thus, a turning maneuver can be implemented with a small space requirement and a turn in one attempt. The axis of rotation, i.e., a pivot point, of the motor vehicle is located precisely at the point of intersection of the connecting lines of the wheels with the same traction. In particular, the wheels rotate at the same speed. In particular, the front wheels are in a straight-ahead position. In other words, the front wheels have no steering angle.

In particular, it can be provided that the off-road turn cannot be implemented on a road because the axis of rotation is in the middle of the lane. In particular, the background to this is that, in the case of a successful turning maneuver with sufficient space, the motor vehicle is later positioned incorrectly in the lane. It can therefore be provided that the maneuver is only permitted off-road. By way of example, it can further be provided that this maneuver is only provided if no trailer is arranged on the motor vehicle. Furthermore, it can be determined, for example, via localisation by means of a global navigation satellite system (GNSS), for example by means of GPS, whether the motor vehicle is off-road or on the road. Furthermore, a speed threshold can be predetermined, for example less than 3 km/h, at which the off-road turn is only permitted. Furthermore, the maneuver can only be permitted once further release conditions, for example from the on-board electrical system, functional safety, product liability or a user interface, have been met.

As a second turning maneuver, for example, a so-called street turn, i.e., a turning maneuver on the road, can be provided. Analogous to the off-road turn, this is a turning maneuver for the road. In the street turn, the wheels of one side of the motor vehicle rotate faster than those of the other side of the motor vehicle, but there is no opposite rotation of the sides. In particular, side of the motor vehicle means a left side of the motor vehicle as viewed in a main driving direction of the motor vehicle and in a longitudinal direction of the motor vehicle, and a right side of the motor vehicle according to the invention. In particular, the respective side is understood to mean the wheels arranged on this side. A left rotation can be implemented by the left side rotating more slowly, or not rotating, relative to the right side. A right rotation can be implemented by the right side rotating more slowly than the left side. For turning on the road, the direction of rotation then also depends on whether one is in a country with traffic driving on the left or the right. In general, the function can display both directions of rotation and then either rotate in the direction desired by the driver or use position data, country and traffic situation recognition, and environment recognition to automatically carry out the rotation in the appropriate direction of rotation for turning on the road.

In particular, it can additionally be implemented that, in contrast to the off-road turn, this maneuver can also be performed in reverse. As a result, a turn in road traffic can also be implemented for the motor vehicle, wherein in particular improved maneuverability and also a small space requirement for the motor vehicle can be implemented during the turn. The turning point of the motor vehicle is located in particular outside the motor vehicle. This means, for example, that a turning maneuver can be implemented in one attempt into the opposite lane. In particular, it can also be implemented that low tire wear occurs for this purpose, since the wheels do not move against one another or one side is stationary, but only a slight rotation of the tires can be implemented, whereby both the small turning circle and the low wear can be implemented.

In particular, a corresponding calculation of the speed ratios of the vehicle sides, i.e., the wheels on one side of the vehicle, can be determined by means of the electronic computing device. In particular, the determination of an axis point as the vertical distance from the center point of the tires on one side can be determined here for the turning maneuver by using the lane width and the motor vehicle width. Depending on a detected position of the motor vehicle relative to the roadway, the speed of the wheels can then additionally be determined. It emerges that, in the case of very narrow lanes and position of the motor vehicle directly next to the central reservation, the axial point should actually be close between the tires of one side. The rotation of the inner wheels is to be minimised and then serves purely to protect the tires.

In particular, it can be further provided in the case of the street turn that, in contrast to the off-road turn, the front wheels are not necessarily brought into the zero position. If the front wheels are not positioned straight ahead, but rather in the direction of the center of the road, the diameter of the inner circle or the track radius is shortened and thus also the value of an outer circle of the wheels. This turning guidance is a desired effect on narrow roads and is therefore allowed.

When detecting the position of the vehicle on the road, the driver assistance system can suggest a direction. If, for example, there is no recognition of the road situation, then a steering angle to be defined or a steering angle that has already occurred can also be used as a direction indication. The steering device then specifies the inner side, the wheels of which rotate at, for example, a maximum of 15% of the speed of the outer wheels. A clear indication of direction is specified when the steering angle exceeds an angle of rotation to be defined. For values in between, a user of the motor vehicle can also alternatively specify the direction of rotation by means of a suitable indication, such as actuation in the desired direction of rotation by means of a suitable indication, such as actuation in the desired direction of the selection lever for indicating the direction of travel (brief flashing), other steering wheel switches, a touch-sensitive input or a voice input.

Inner side means, in particular during the turn, the side that has a smaller distance relative to the center of rotation than the outer side.

In particular, the street turn is only permitted if the motor vehicle does not have a trailer, as well as if a speed of the motor vehicle is below a value to be defined, for example less than 3 km/h.

In a further advantageous design, a parking maneuver for parking the motor vehicle can additionally be provided as a third driving mode by means of the driver assistance system. Furthermore, a so-called jogging mode can be provided as an additional driving mode. The jogging mode is in particular a so-called “rocking free mode”. This is a maneuver which, by means of slight movement, enables rocking free from, for example, a stuck base of the motor vehicle, in particular off-road. This can be implemented, for example, by slightly moving the wheels back and forth to regain traction. This can potentially also be implemented by briefly rotating the wheels in opposite directions to regain material for traction.

The parking maneuver can, for example, be so-called agile parking. During the parking maneuver, in particular automatic parking, the parking trajectory is changed by using different wheel speeds or torques on the respective sides of the motor vehicle. This makes it possible to park in one attempt in spaces that would otherwise have to be approached in several attempts. For this purpose, it can be provided, for example, that the electronic computing device determines a driving line, i.e., a parking trajectory, into the parking space with which the parking maneuver can be undertaken in one attempt. Wherever the trajectory can no longer be followed by normal steering, the different wheel speed of the vehicle sides helps to rotate the motor vehicle in further. In particular, it can be provided for this purpose, for example, that the algorithm for parking is based on an overlap of two functions. By way of example, normal steering of the motor vehicle can be implemented based on the steering of the front wheels, wherein additional steering can be performed by different wheel speeds on the two vehicle sides.

Furthermore, it has proved advantageous if at least the first or second driving mode can be set by means of a touch-sensitive display device of the driver assistance system and/or by means of a steering device of the motor vehicle and/or by means of a switching device of the motor vehicle and/or by means of a voice input device as the respective actuating device. In other words, a user of the driver assistance system can select the first driving mode or the second driving mode via the different actuating devices. These can be implemented, for example, by touching the touch-sensitive display devices. Furthermore, the corresponding driving mode can be selected by means of a steering device, which can be implemented, for example, by a steering wheel of the motor vehicle. This can be implemented, for example, by the direction specification by means of the steering wheel. In particular, the turning direction can be determined depending on the steering angle. Furthermore, it can be provided that the corresponding driving mode can be set by means of a switching device, which is provided, for example, as gear selection rockers, on the steering wheel. Furthermore, the user can select the corresponding driving mode, for example, by voice input by means of the voice input device. Alternatively, it is also possible that the first or the at least second driving mode is set by means of a knob selection. A speed setting can be implemented, for example, via an accelerator pedal setting or via the brake. This makes it possible to perform the first driving mode or the second driving mode without additional components in the motor vehicle.

It is also advantageous if the driver assistance system is used to operate the motor vehicle at least partially autonomously, in particular fully autonomously, in at least the first driving mode and in at least the second driving mode. By way of example, parking can be performed fully autonomously. Furthermore, steering can be implemented autonomously as well as the speed adjustment via accelerator pedal. For the first driving mode, the “off-road turn”, the control could also take place without actuation of the accelerator pedal, for example by performing the driving mode exclusively via a rotation or angle of rotation of the steering wheel against a haptic resistance. A force applied by the user or a magnitude of the steering angle can then be assigned to a rotational speed of the vehicle. Increasing the force applied or the steering angle against the haptic resistance makes the vehicle rotate faster, for example. In this case, even small steering angles on the steering wheel are sufficient, such that the steering wheel only has to rotate minimally and, depending on the design of the vehicle, only a very small steering angle of the wheels occurs or, for example, with a steer-by-wire function, the rotating of the wheels themselves can also be completely omitted. In particular, this enables the most comfortable operation of the motor vehicle possible to be implemented by means of the driver assistance system.

In a further advantageous embodiment, the motor vehicle is provided as an at least partially off-road motor vehicle. In particular off-road, turning in small spaces is necessary. In particular, the method according to the invention can thus implement improved turning off-road, such that an improved operation of the motor vehicle, in particular as an at least partially off-road motor vehicle, can be implemented.

According to a further advantageous embodiment, a steering angle of a steering device of the motor vehicle and/or an inclination of the motor vehicle relative to a surface on which the motor vehicle is located can be taken into account when generating the four control signals. In particular, both a current steering angle of the motor vehicle, which for example has already been turned by the user, can be taken into account. Furthermore, it can also be taken into account whether, for example during the parking maneuver by means of the driver assistance system, active steering of the two front wheels, for example, is to be used in order to be able to implement the corresponding turning circle. This makes it possible for the motor vehicle to be provided with improved maneuverability.

Furthermore, it can be provided that an environment of the motor vehicle is detected by means of a detection device of the motor vehicle and the detected environment is also taken into account when generating the four control signals. In particular, the environment of the motor vehicle can be detected, for example, by means of a camera device as a detection device. This means, for example, that the side of the road and the width of the road on which the motor vehicle is located can be recognised or detected, which in turn allows a center of rotation for turning to be determined. Particularly in the case of a 180° turning maneuver, the center of rotation can be determined in an improved manner. Furthermore, monitoring of the environment can be implemented by means of the detection device, such that a warning or stopping of the turning process can optionally take place, should it be determined that the motor vehicle could collide with something due to the turning circle. In particular, the environment can be displayed, for example, on the display device, wherein in particular a so-called bird's eye view with the motor vehicle and the corresponding center of rotation and trajectory can be displayed.

It is further advantageous if at least one parameter characterizing the set driving mode is displayed on the display device by means of a display device of the driver assistance system. In particular, the driving mode can thus be displayed together with the 360° camera perspective or various settings of the individual driving modes. In this way, it is conveniently possible for a user to operate the motor vehicle.

Furthermore, it is advantageous if a center of rotation and/or a driving mode speed and/or a rotation radius is displayed as the parameter characterizing the set driving mode, wherein in particular the parameter characterizing the set driving mode is set by a user. By way of example, a speed of the driving mode can be set by the user. In particular, the center of rotation is displayed on the display device such that the user can see how the vehicle is positioned relative to, for example, the road after the driving mode. This enables the user to perform the planning of the driving mode. Furthermore, for example, the user can observe the environment accordingly and decide, for example, a point in time when the driving mode can start without endangering road safety. In particular, for this purpose, the current center of rotation and/or the desired center of rotation can be displayed in relation to the motor vehicle, most advantageously in a bird's eye view, with the environment. In particular, the settings can be changed accordingly, for example by performing a shift of the center of rotation by the user.

Furthermore, it is advantageous if at least the first driving mode and/or at least the second driving mode is aborted depending on an aborting criterion. In other words, it can be provided that the driving mode is aborted should a corresponding aborting criterion be met. By way of example, a respective driving mode may be aborted should a tighter turning circle allow the motor vehicle to collide with something. In addition, some driving modes should only be offered in appropriate environments, for example, the off-road turn should only be allowed on rough terrain, while the parking maneuver may be used when the parking space is detected. As a further aborting criterion, it can be considered, for example, that the jogging mode can only be provided off-road.

A further aspect of the invention relates to a driver assistance system for an at least partially electrically operable motor vehicle having at least one electronic computing device and having an actuating device, wherein the driver assistance system is designed to carry out a method according to the preceding aspect. In particular, the method is performed by means of the driver assistance system.

A yet further aspect of the invention relates to a motor vehicle having a driver assistance system according to the preceding aspect and having four wheels which can be driven independently of one another. In particular, the motor vehicle is at least partially formed as an off-road vehicle and is at least partially electrically operable.

Advantageous designs of the method are to be regarded as advantageous designs of the driver assistance system as well as of the motor vehicle. For this purpose, the driver assistance system as well as the motor vehicle have objective features which enable implementation of the method or an advantageous embodiment thereof.

Further advantages, features and details of the invention emerge from the following description of preferred exemplary embodiments and from the drawings. The features and combinations of features mentioned above in the description, as well as the features and combinations of features mentioned below in the description of figures and/or shown alone in the figures, can be used not only in the combination indicated in each case, but also in other combinations or on their own, without departing from the scope of the invention.

### BRIEF DESCRIPTION OF THE DRAWINGS

FIG. 1 is a schematic top view of an embodiment of a motor vehicle in a first driving mode;

FIG. 2 is a further schematic top view of an embodiment of the motor vehicle in a second driving mode; and

FIG. 3 is a further schematic top view of an embodiment of the motor vehicle in a third driving mode.

### DETAILED DESCRIPTION OF THE DRAWINGS

In the figures, identical or functionally identical elements are provided with identical reference numerals.

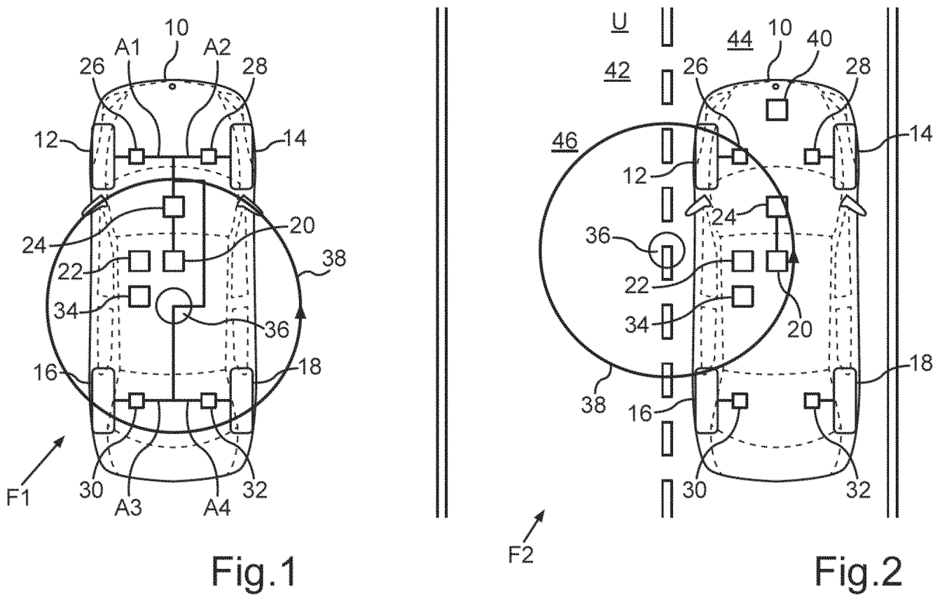

FIG. 1 shows a schematic top view of an embodiment of a motor vehicle 10. In particular, the motor vehicle 10 is provided as an at least partially off-road motor vehicle 10.

The motor vehicle 10 has a first wheel 12, a second wheel 14, which together form the front wheels 12, 14. Furthermore, the motor vehicle 10 has a third wheel 16 and a fourth wheel 18, wherein the third wheel 16 and the fourth wheel 18 form the rear wheels 16, 18.

In the method for operating a driver assistance system 20 of the at least partially electrically operable motor vehicle 10, the first wheel 12 is driven by means of a first control signal A1, the second wheel 14 is driven by means of a second control signal A2, the third wheel 16 is driven by means of a third control signal A3, and the fourth wheel 18 is driven by means of a fourth control signal A4. A first driving mode F1 is provided for the motor vehicle 10 depending on the fourth control signals A1, A2, A3, A4.

It is provided that at least a second driving mode F2 (FIG. 2) is provided depending on the four control signals A1, A2, A3, A4, wherein the first driving mode F1 or the second driving mode F2 is set by means of an actuating device 22 of the driver assistance system 20 by a single user input, and the four control signals A1, A2, A3, A4 are generated depending on the user input by means of an electronic computing device 24 of the driver assistance system 20 for controlling the four wheels 12, 14, 16, 18 depending on the set driving mode F1, F2.

The first driving mode F1 and the second driving mode F2 are to be understood in particular as a respective driving maneuver, i.e., the movement of the motor vehicle 10.

In particular, it can be provided that different speeds and/or torques and/or directions of movement of the four wheels 12, 14, 16, 18 are respectively set by means of the four control signals A1, A2, A3, A4. Furthermore, it can be provided that a respective wheel 12, 14, 16, 18 is driven by means of a respective electric motor 26, 28, 30, 32 assigned to the wheel 12, 14, 16, 18. In particular, according to FIG. 1, the first wheel 12 is driven by means of a first electric motor 26. The second wheel 14 is driven by means of a second electric motor 28. The third wheel 16 is driven by means of a third electric motor 30. The fourth wheel 18 is driven by means of a fourth electric motor 32.

Furthermore, it can be provided that at least the first or the second driving mode F1, F2 are set by means of a touch-sensitive display device 34 of the driver assistance system 20 and/or by means of a steering device of the motor vehicle 10 and/or by means of a switching device of the motor vehicle 10 and/or by means of a voice input device as the respective actuating device 22.

Furthermore, it can be provided that, by means of the driver assistance system 20, the motor vehicle 10 is operated at least partially autonomously, in particular fully autonomously, in the at least first driving mode F1 and/or at least second driving mode F2.

Furthermore, it can be provided that, by means of the display device 34 of the driver assistance system 20, at least one parameter characterizing the set driving mode F1, F2 is displayed on the display device 34. In particular, a center of rotation 36 and/or a driving mode speed and/or a rotation radius 38 can be displayed as the parameter characterizing the set driving mode F1, F2, wherein in particular the parameter characterizing the set driving mode F1, F2 is set by a user.

FIG. 1 shows that, in particular, a first turning maneuver of the motor vehicle 10 can be provided as the first driving mode F1. The first turning maneuver can in particular be a turn of the motor vehicle 10 on rough terrain. The first driving mode F1 can also be referred to as an off-road turn. In the off-road turn, the first wheel 12 and the third wheel 16 rotate in a first direction and the second wheel 14 and the fourth wheel 18 rotate in the opposite direction. A left rotation of the motor vehicle 10 can then be implemented, for example, by the left side, in particular the wheels 12, 16 of the left side, of the motor vehicle 10 rotating backwards as viewed in the longitudinal direction of the motor vehicle 10 and in a main driving direction of the motor vehicle 10, and the right side, in particular the wheels 14, 18 of the right side, rotating forwards. A right rotation can be implemented, for example, by rotating the right side backwards and the left side forwards. In this way, a high degree of maneuverability off-road can be implemented, in particular with a low space requirement. In this case, the axis of rotation, i.e., the center of rotation 36, is located exactly at the point of intersection of the connecting lines of all wheels 12, 14, 16, 18, with the same traction. In particular, all wheels 12, 14, 16, 18 rotate at the same speed. The front wheels 12, 14 are in a straight-ahead position. In particular, it can be provided that the first driving mode F1 is not suitable for a road 42 (FIG. 2), since the center of rotation 36 would be located in the middle of a driving lane 44 (FIG. 2). Thus, even if the maneuver is successful with sufficient space, the motor vehicle 10 will later be in the wrong lane. It is therefore provided that the maneuver is only permitted off-road.

The first driving mode F1 can, for example, be started by a button as soon as appropriate conditions are met. By way of example, it can be provided that no trailer is to be attached to the motor vehicle 10, and/or that it is detected by means of a navigation device of the motor vehicle 10 whether the motor vehicle 10 is located off-road. If the motor vehicle 10 is off-road, the first driving mode F1 can be performed. Furthermore, the speed of the motor vehicle 10 may be below a value to be defined, such that the first driving mode F1 can be performed. If these conditions are not met, the display device 34 can indicate that maneuvering is not possible. Further enabling conditions may come, for example, from the on-board electrical system, from functional safety, product liability or from a user interface. Provided that all conditions are fulfilled, the functional release for maneuver activation is present.

It may be provided in the first step that each of the wheels 12, 14, 16, 18 locks and brings the motor vehicle 10 to a stop. There may then be a confirmation by a function LED and the combination message indicating the next step. A staging of the first driving mode F1 may then be performed on the display device 34, for example. In particular, a 360° view can be provided by means of a detection device 40 (FIG. 2), which can be designed in particular as a camera, such that in particular a bird's-eye view staging of the driving mode F1 can be displayed. The steering wheel rotates to zero position and thereby brings the front wheels 12, 14 into the straight-ahead position. In particular, it can be provided that the angular velocity of the rotation of the wheels 12, 14, 16, 18 thereby descends a ramp such that it is perceived by the user as a smooth start and end of the rotation. As soon as the zero position is reached, the request for specification of the direction for the first driving mode F1 appears in the instrument cluster, in particular on the display device 34. It is then possible for direction to be predetermined by, for example, the steering wheel of the motor vehicle 10 or by the direction indicator of the motor vehicle 10, which may also be referred to as the indicator switch. In the case of the steering wheel, for example, an electric steering system can detect a force that wants to move the steering wheel from the 12 o'clock position to the predetermined direction. The pressure is yielded to from a threshold torque to be defined, such that a defined maximum angle change can occur, such that an increased torque then becomes active as resistance of the steering. This can generate haptic feedback for the user. The direction specification is detected as long as the necessary force is applied to maintain the threshold torque. Feedback may thereby be provided on the display device 34 with the staging of the directional selection. A message can then appear on the display device 34, indicating that the directional selection can be maintained. The accelerator pedal can be actuated to start the first driving mode F1. Likewise, it is possible that, depending on the design of the system, the steering direction specification in conjunction with the force-sensitive measurement of the torque or the angle of rotation at the steering wheel can already be used as a specification for activating and starting the maneuver. If the value falls below the threshold torque, the message after direction specification appears in the instrument cluster until the old state with function release above the threshold value is reached again.

By actuating the direction indicator, the direction to be rotated can alternatively be indicated. Feedback can be provided via the display device 34 with the staging of the first driving maneuver F1. As long as the driving direction indicator is placed in the position of a driving direction specification, the function release for the next step is also present. Furthermore, the operation can also be performed by the touch-sensitive display device 34. By means of the selection device option on the display device 34, the direction to be driven can be specified as an alternative to operation by means of the steering wheel. As long as the selection is not deselected, the function release for the next step is also present. Feedback can be provided on the display device 34 with the staging of the first driving maneuver F1. In particular, the message that the corresponding device for carrying out the driving maneuver is to be actuated appears subsequently, such that, for example, the accelerator pedal is to be actuated, provided that carrying out the method for the driving maneuver involves actuating an accelerator pedal. Alternatively, a selection can be made by means of the voice input device, provided that the selection is active, the voice control responds to the command, for example, right or left, and can confirm the specification. As long as the selection is not deselected, the function release for the next step is also present.

Once again, alternatively, the direction can also be specified by the switching device, in particular by a gearshift paddle, i.e., a gear selection lever, in particular on the steering wheel.

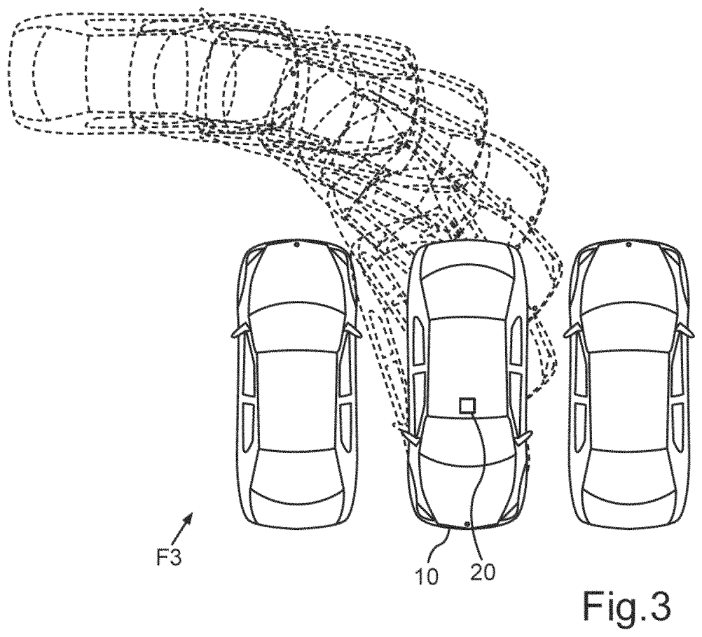

The accelerator pedal can then be used to execute the first driving mode F1. The first driving mode F1 can thus ultimately be started by means of the accelerator pedal. The accelerator pedal position can be assigned to a rotational speed to be defined by passing through a ramp function. Should, for example, the user no longer operate the accelerator pedal, a gentle deceleration of the motor vehicle 10 can be initiated and, for example, a recuperation can be performed such that there is little over-travelling. With renewed accelerator pedal movement, the motor vehicle 10 can be moved further, provided that the release conditions for this step are still present. From the base position, the gentle deceleration ramp is run through again. The release steps must be executed in cascade, in particular. Removal of a step does not abort the entire maneuver, but rather the new activation of the step takes place. However, the first driving mode F1 is aborted in particular in each state by pressing the dedicated maneuver key again. However, the first driving mode F1 is aborted in particular in each state by pressing the dedicated maneuver key again. In particular, the first driving mode F1 must be actively terminated by pressing the key associated with the first driving mode F1 again such that another driving mode F1, F2 (FIG. 2), F3 (FIG. 3) can be selected. In particular, it can be provided that, as soon as the maneuver request is removed via the respective input, the steering is also no longer locked and the motor vehicle 10 reacts normally, for example for a regular driving operation of the motor vehicle 10. Alternatively, instead of actuation of the accelerator pedal, the maneuver can also be performed via a force-sensitive evaluation of the steering torque. This variant then includes, for example, the steps of specifying the direction and starting the maneuver.

Furthermore, it can be provided, for example, that the first driving mode F1 is stopped if a prerequisite for the first driving mode F1 is not fulfilled. This can be fulfilled, for example, if a direction specification is no longer present or if the accelerator pedal is no longer depressed. An abortion of the first drive mode F1 can furthermore be carried out, should the switching state be aborted via a renewed pressing. A function LED can then go out. Furthermore, it can also be input via voice command that the first driving mode F1 is to be aborted. For this purpose, the driver assistance system 20 can then be configured, for example, to provide feedback to the user that the first driving mode F1 has been aborted.

FIG. 2 shows the motor vehicle 10 in a schematic top view during the second driving mode F2. The second driving mode F2 is in particular a turning maneuver, which is different from the first turning maneuver, i.e., the off-road turn. In particular, it is a turning maneuver of the motor vehicle 10 on a road 42. The road 42 has a first lane 44 in which the motor vehicle 10 is currently located and a second lane 46 which may be referred to as the opposite lane. In the second driving mode F2, in particular a steering angle of a steering device of the motor vehicle 10 and/or an inclination of the motor vehicle 10 relative to a ground on which the motor vehicle 10 is located can be taken into account in the generation of the four control signals A1, A2, A3, A4. Furthermore, FIG. 2 shows that an environment U of the motor vehicle 10 is detected by means of the detection device 40 of the motor vehicle 10, and the detected environment U is taken into account in the generation of the four control signals A1, A2, A3, A4. The second driving mode F2, which describes the turning on the road 42, can in particular also be referred to as a street turn.

The individual steps can be performed analogously to the off-road turn. In the street turn, the wheels 12, 16 rotate at a first speed and the wheels 14, 18 turn at a second speed, wherein all four wheels 12, 14, 16, 18 move in the same direction. A left rotation can take place by the wheels 12, 16 rotating slowly to not rotating at all while the wheels 14, 18 rotate quickly. A right rotation can be implemented by the wheels 14, 18 rotating slowly to not rotating at all while the wheels 12, 16 rotate quickly. This example involves a turn in the forward direction. Alternatively, the motor vehicle 10 can also rotate in a reverse motion. In this way, a high degree of maneuverability in road traffic can be implemented. If the wheels 12, 14, 16, 18 of one side do not rotate at all, the axis of rotation, in other words the center of rotation 36, is located at the intersection of the two wheel contact surfaces of the non-rotating side. As a result, tire wear may be increased. In particular, it is therefore provided that a slight co-rotation of the other wheels 12, 14, 16, 18 in this exemplary embodiment, i.e., of the side towards the inside of the roadway, is also carried out. The speed ratio of the tires 12, 14, 16, 18 to one another can be determined in particular by determining the center of rotation 36 as the vertical distance from the center of the wheels 12, 16 in this exemplary embodiment for the maneuver, i.e., the second driving mode F2. Furthermore, roadway width and a known width of the motor vehicle 10 in particular are necessary for the determination. In particular, it emerges that, if the roadway 42 is very narrow and the position of the motor vehicle 10 is directly adjacent to a central reservation of the roadway 42, the center of rotation 36 should actually be close between the tires 12, 16 in this exemplary embodiment. The rotation of the inner wheels 12, 16 is to be minimised and in particular then serves purely to protect the wheels 12, 16 from wear.

In particular, it can be provided that the rotation of the inner wheels 12, 16 describes an inner circle around which the motor vehicle 10 rotates. If the motor vehicle 10 is at the far left of the lane 44 and the lane width is at the minimum, then the vehicle width results in a maximum inner circle diameter in order to be able to start from the center of the wheel support. In contrast to the off-road turn, in the second driving mode F2 the front wheels 12, 14 cannot necessarily be brought into the zero position, in particular performing a steering angle. If the front wheels 12, 14 should then not be in a straight line but rather in the direction of the center of the roadway, the diameter of the inner circle is shortened and thus also that of the outer circle. The narrower guidance is a desired effect on narrow roads and is allowed to occur. The effect must be taken into account when detecting the lanes 44, 46 and the position of the motor vehicle 10. If there is no detection of the road situation, then the steering angle is used as a direction specification. The steering device indicates to the wheels 12, 16 of the inner side that they rotate with, for example, a maximum of 15% of the speed of the outer wheels 14, 18. A clear direction indication is present if the steering angle exceeds an angle of rotation to be defined. For values in between, the user must specify the direction of rotation himself/herself. The individual steps for performing the street turn are analogous to the steps for performing the off-road turn.

In particular, by using the detection device 40, in particular by using cameras on board the motor vehicle 10, the width of the road 42, as well as the position of the motor vehicle 10 within the respective lane 44, 46, can be determined. It is now possible to design the rotation such that the motor vehicle 10 is in the center of the lane 46 after the second driving mode F2. By means of a specifically determined rotational speed of the inner wheels 12, 16 relative to the outer wheels 14, 18, a path in the direction of the inner side can be bridged via a semi-circular path within the rotation.

If the motor vehicle 10 is on the road 42 with a steering angle, it is a superimposed movement from the case without steering angle and the circular path taken by the steering. In particular, a correction is necessary as a result. In particular, the steering angle, the slip angle, the yaw rate and a side slip angle can be taken into account for correction.

Alternatively, it can be provided that the user himself/herself can determine the center of rotation 36, for example via the touch-sensitive display device 34. The driver assistance system 20 can determine, in particular in real time, a resulting trajectory and suggest it accordingly to the user and display it, for example, on the display devices 34.

Alternatively, a jogging mode can be provided as a further driving mode. The jogging mode, which can be carried out in particular off-road and is also referred to, for example, as rocking-free mode, is an automatic program which enables rocking free from stuck ground by means of slight movements. This can be done, for example, by the combination of performing a slight back and forth movement of the wheels 12, 14, 16, 18, such that the wheels 12, 14, 16, 18 regain traction. Furthermore, a short counter-rotation of the wheels 12, 14, 16, 18 can also be performed in order to regain traction.

FIG. 3 shows, in a schematic top view, an embodiment of the motor vehicle 10 in a third driving mode F3. The third driving mode F3 is in particular a parking maneuver for parking the motor vehicle 10.

During the parking process, which is in particular carried out at least partially autonomously, in particular fully autonomously, parking is performed with the aid of different wheel speeds on the respective vehicle sides, such that the angle of entry is varied. Thus, in the third driving mode F3, it is possible to park in parking spaces in one attempt, which would otherwise have to be approached in several attempts. The motor vehicle 10, in particular the electronic computing device 24, determines a driving line for the parking space with which the third driving mode F3 can be driven in one attempt. Whenever the driving line can no longer be driven by normal steering, the electronic computing device 24 determines a different wheel speed of the wheels 12, 14, 16, 18 on the respective vehicle sides, in order to be able to rotate the motor vehicle 10 in further.

In particular, this algorithm is based on the superposition of two functions. Normal control of the motor vehicle 10 can be performed based on steering of the front wheels 12, 14. Such steering can be implemented by the wheel speed on the two sides of the vehicle. In particular, the electronic computer calculation 24 determines at least three functions for this purpose. In particular, an ideal line to approach the parking space is determined as the first function. Furthermore, a line which is possible by normal steering movements is determined as the second function. The subtraction of the two functions results in a necessary third function. This third function is the specification for the steering by different wheel speeds of the two sides. At the beginning, the steering functions for normal steering and the longitudinal controller interface are used, and finally the third function for controlling the wheel speed. Both run in particular simultaneously during the parking maneuver.

The parking maneuver according to the invention, i.e., the third driving mode F3, is in particular a functional extension of normal parking. In particular, a selection can be made via the parking maneuver menu. If the parking space can be approached in one attempt without a corresponding support, the option is also not displayed. In the other case, the user can choose to approach the parking space normally or with an appropriate support. For this purpose, the driver assistance system 20 estimates the number of attempts required for normal parking and how many are required by using the different wheel speeds. In particular, this can also be displayed on the display device 34. A corresponding staging of the third driving mode F3 can also be displayed on the display device 34.

In a further embodiment, the driver can, for example, select the “torque vectoring” option in the vehicle, in particular via a switch or a menu of the control system, and during a parking process, which can then take place directly or even at a later time during the activation of the “torque vectoring” option; this will then always take place via the third driving mode F3. This means that the driver does not have to select or confirm the third driving mode F3 again separately for parking, if this would be necessary to be able to drive into the parking space in one attempt. In this case, when the parking process is started, support occurs automatically in accordance with the third driving mode F3 with different wheel speeds and the display device 34 indicates this accordingly.

It can further be provided that the different control of the wheels 12, 14, 16, 18 is also used during a normal driving operation of the motor vehicle 10. This may, for example, be so-called agile controlling. Agile controlling allows dynamic driving by means of different rotational speeds of the wheels 12, 14, 16, 18 during regular driving operation. Thus, depending on the driving speed of the motor vehicle 10, more torque is allocated to the wheels 12, 14, 16, 18 on the outside of the bend, such that a steering movement already occurs due to the different distribution of the torque. The torque allocation starts with a maximum value and ends with a speed to be defined, at which the torque differences between the vehicle sides then decrease to zero. As a result, higher dynamics can be implemented on the road.

In particular, torque vectoring can enable smaller turning circles at low speeds according to the actuation by relative speeds of the wheels, wherein, however, this is reduced at higher speeds via the actuation. By way of example, the system can be made available via a switch in the region of the center console or cockpit as a central switch for activating and/or deactivating the torque vectoring functions and/or agile parking.

A method described herein can also be in the form of a computer program (product) that implements the method on a control unit when executed on the control unit. Similarly, an electronically readable data carrier having electronically readable control information stored thereon may be present, which information comprises at least one described computer program product and is configured to implement a described method when the data carrier is used in a control unit of an MR system.

Overall, the invention shows new driving maneuvers for four individually driven wheels 12, 14, 16, 18 and their operation.

### LIST OF REFERENCE CHARACTERS

10 motor vehicle
12 first wheel
14 second wheel
16 third wheel
18 fourth wheel
20 driver assistance system
22 actuating device
24 electronic computing device
26 first electric motor
28 second electric motor
30 third electric motor
32 fourth electric motor
34 display device
36 center of rotation
38 rotation radius
40 detection device
42 road
44 lane
46 lane
A1 first control signal
A2 second control signal
A3 third control signal
A4 fourth control signal
F1 first driving mode
F2 second driving mode
F3 third driving mode
U environment

1.-15. (canceled)

16. A method for operating a driver assistance system (20) of an electrically driven motor vehicle (10), wherein a first wheel (12) of the motor vehicle (10) is driven via a first control signal (A1), a second wheel (14) of the motor vehicle (10) is driven via a second control signal (A2), a third wheel (16) of the motor vehicle (10) is driven via a third control signal (A3), and a fourth wheel (18) of the motor vehicle (10) is driven via a fourth control signal (A4), and wherein the wheels (12, 14, 16, 18) are each driven via a respective electric motor (26, 28, 30, 32) assigned to the respective wheel (12, 14, 16, 18), comprising the steps of:
providing a first driving mode (F1) depending on the four control signals (A1, A2, A3, A4);
providing a second driving mode (F2) depending on the four control signals (A1, A2, A3, A4);
setting the first driving mode (F1) or the second driving mode (F2) via an actuating device (22) by a single user input;
wherein the four control signals (A1, A2, A3, A4) are generated depending on the single user input by an electronic computing device (24) of the driver assistance system (20) for controlling the four wheels (12, 14, 16, 18) depending on the set driving mode (F1, F2);
wherein a first turning maneuver of the motor vehicle (10) is set as the first driving mode (F1);
wherein a second turning maneuver of the motor vehicle (10) is set as the second driving mode (F2), wherein the second turning maneuver is different from the first turning maneuver;
wherein, during the first turning maneuver, a direction of movement for each of the four wheels (12, 14, 16, 18) is respectively set via the four control signals (A1, A2, A3, A4) such that respective wheels (12, 14, 16, 18) of a right side of the motor vehicle (10) and respective wheels of a left side of the motor vehicle (10) rotate against each other;
wherein via the driver assistance system (20), the motor vehicle (10) is operated at least partially autonomously at least during the first driving mode (F1) and/or the second driving mode (F2).

17. The method according to claim 16, wherein a speed and/or a torque and/or a direction of movement of each of the four wheels (12, 14, 16, 18) is set via the respective control signal (A1, A2, A3, A4).

18. The method according to claim 16, wherein a parking maneuver for parking the motor vehicle (10) is provided as a third driving mode (F3) by the driver assistance system (20).

19. The method according to claim 16, wherein the actuating device is a touch-sensitive display device (34) of the driver assistance system (20) and/or a steering device of the motor vehicle (10) and/or a switching device of the motor vehicle (10) and/or a voice input device (22).

20. The method according to claim 16, wherein the motor vehicle (10) is an at least partially off-road motor vehicle (10).

21. The method according to claim 16, wherein a steering angle of a steering device of the motor vehicle (10) and/or an inclination of the motor vehicle (10) relative to a ground on which the motor vehicle (10) is located are taken into account when generating the four control signals (A1, A2, A3, A4).

22. The method according to claim 16, wherein an environment (U) of the motor vehicle (10) is detected by a detection device (40) of the motor vehicle (10) and wherein the detected environment (U) is taken into account when generating the four control signals (A1, A2, A3, A4).

23. The method according to claim 16, wherein at least one parameter characterizing the set driving mode (F1, F2) is displayed on a display device (34) of the driver assistance system (20).

24. The method according to claim 16, wherein a center of rotation (36) and/or a driving mode speed and/or a radius of rotation (38) is displayed as a parameter characterizing the set driving mode (F1, F2).

25. The method according to claim 16, wherein at least the first driving mode (F1) and/or at least the second driving mode (F2) is aborted depending on an abortion criterion.

26. A driver assistance system (20) of an electrically drivable motor vehicle (10), comprising:
an electronic computing device (24); and
an actuating device (22);
wherein the driver assistance system (20) is configured to perform the method according to claim 16.

27. A motor vehicle (10), comprising:
the driver assistance system (20) according to claim 26; and
four wheels (12, 14, 16, 18) which are drivable independently of one another.
